(19) United States
(12) Patent Application Publication
(10) Pub. No.: US 2019/0011711 A1
(43) Pub. Date: Jan. 10, 2019

(54) WEARABLE DEVICE

(71) Applicants: Fu Tai Hua Industry (Shenzhen) Co., Ltd., Shenzhen (CN); HON HAI PRECISION INDUSTRY CO., LTD., New Taipei (TW)

(72) Inventors: HAO-YUAN HUANG, New Taipei (TW); CHIA-JUI HU, New Taipei (TW); CHUN-KAI PENG, New Taipei (TW); HSU-MIN KUO, New Taipei (TW)

(21) Appl. No.: 15/802,400

(22) Filed: Nov. 2, 2017

(30) Foreign Application Priority Data
Jul. 7, 2017 (CN) 201710553020.5

(51) Int. Cl. G02B 27/01; G06F 1/16; G06F 3/01

(52) U.S. Cl. CPC G02B 27/0176; G06F 1/163; G06F 3/011; G02B 2027/0156; G02B 2027/0178; G02B 2027/0138; G02B 27/0172

(57) ABSTRACT

A wearable device includes a frame and a display element is provided. The frame internally includes a sliding element. The display element is attached to the sliding element and can slide on the sliding element to be brought in front of the wearer's eye or away from the wearer's eye.

### CROSS-REFERENCE TO RELATED APPLICATIONS

This application claims priority to Chinese Patent Application No. 201710553020.5 filed on Jul. 7, 2017, the contents of which are incorporated by reference herein.

### FIELD

The present invention relates to a wearable device.

### BACKGROUND

Generally, when a user does not use a wearable device that includes a display device, the user needs to take off the wearable device. Therefore, there is a room for improvement.

### BRIEF DESCRIPTION OF THE DRAWINGS

Implementations of the present disclosure will now be described, by way of example only, with reference to the attached figures.

FIG. 1 is an isometric view showing an exemplary embodiment of a wearable device.

FIG. 2 is an isometric view showing the wearable device of FIG. 1 from another view.

FIG. 3 illustrates an exemplary embodiment of a driving portion included in the wearable device of FIG. 1.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the exemplary embodiments described herein. However, it will be understood by those of ordinary skill in the art that the exemplary embodiments described herein can be practiced without these specific details. In other instances, methods, procedures, and components have not been described in detail so as not to obscure the related relevant feature being described. The drawings are not necessarily to scale and the proportions of certain parts may be exaggerated to better illustrate details and features. The description is not to be considered as limiting the scope of the exemplary embodiments described herein.

The term “comprising” means “including, but not necessarily limited to”; it specifically indicates open-ended inclusion or membership in a so-described combination, group, series, and the like.

Exemplary embodiments of the present disclosure will be described in relation to the accompanying drawings.

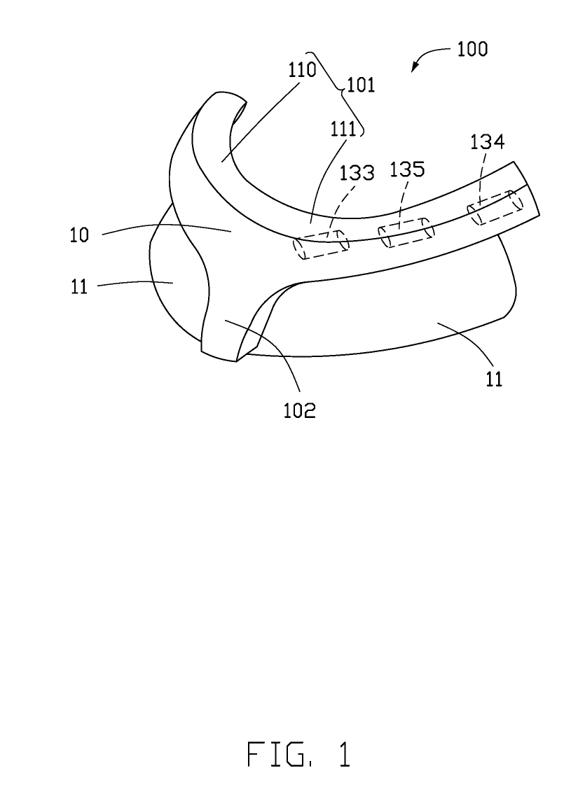

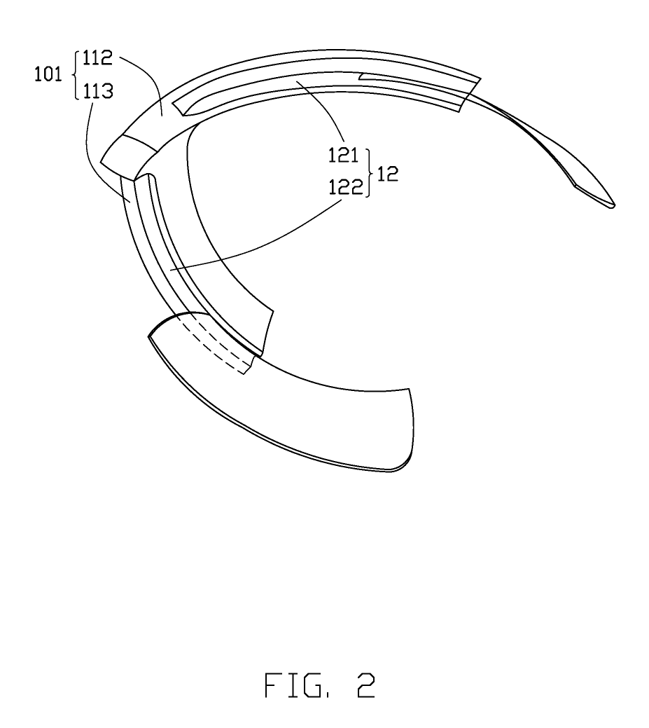

FIGS. 1-2 illustrate an exemplary embodiment of a wearable device 100. The wearable device 100 can be a virtual reality device, smart glasses, or three dimensional glasses. It should be noted that the wearable device 100 can further include other elements such as electronic elements and at least one software program.

The wearable device 100 includes a frame 10 and a display element 11. The frame 10 is internally configured with a sliding element 12 and a driving element 13. In at least one exemplary embodiment, the display element 11 includes two display devices. The display element 11 can be configured on the sliding element 12. The driving element 13 can drive the display element 11 to slide on the sliding element 12.

The frame 10 includes a support portion 101 and an extending portion 102. In at least one exemplary embodiment, the support portion 101 has a “U” shape that matches with a human face. Therefore, the wearable device 100 is convenient for a user to wear. One end of the extending portion 102 connects with the support portion 101, and another end of the extending portion 102 extends away from the support portion 101. In at least one exemplary embodiment, the extending portion 102 and the support portion 101 are integrated. The support portion 101 includes a first support 110 and a second support 111. In at least one exemplary embodiment, the first support 110 and the second support 111 are symmetrical around portion 102. The first support 110 and the extending portion 102 construct a first opening space to receive one display device of the display element 11. The second support 111 and the extending portion 102 construct a second opening space to receive another display device of the display element 11.

As shown in FIG. 2, the first support 110 includes a first bottom wall 112 and the second support 111 includes a second bottom wall 113. The first bottom wall 112 and the second bottom wall 113 are located at one side of the supporting portion 101 that connects with the extending portion 102. The sliding element 12 includes a first sliding rail 121 and a second sliding rail 122. The first sliding rail 121 is configured at the first bottom wall 112, the second sliding rail 122 is configured at the second bottom wall 113. In at least one exemplary embodiment, each of the first sliding rail 121 and the second sliding rail 122 has a groove. The first bottom wall 112 is inwardly grooved to the first support 110 to form the first sliding rail 121. The second bottom wall 113 is inwardly grooved to the second support 111 to form the second sliding rail 122. In at least one exemplary embodiment, the groove of the first sliding rail 121 and of the second sliding rail 122 match with a thickness of the display device of the display element 11, such that the two display devices can respectively slide in the first sliding rail 121 and the second sliding rail 122. In at least one exemplary embodiment, the first sliding rail 121 and the second sliding rail 122 represents an arc-shape overall. Each of the first support 110 and the second support 111 extends from a position near the extending portion 102 to a position that is away from a terminal of the extending portion 102. The first sliding rail 121 cuts through the first support 110 and extends away from the terminal of the extending portion 102. The second sliding rail 122 cuts through the second support 111 and extends away from the terminal of the extending portion 102. The extending portion 102 can prevent collision between the two display devices of the display element 11. The extending portion 102 also has a support function when the user wears the wearable device 100.

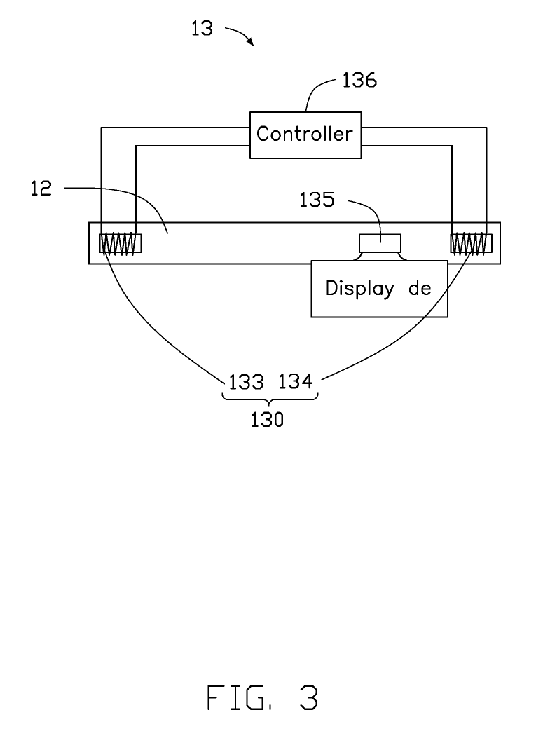

As shown in FIG. 3, the driving element 13 is configured at the support portion 101. In at least one exemplary embodiment, the driving element 13 includes a fixing part 130, a sliding object 135, and a controller 136. The controller 136 can control the sliding object 135 to slide along the sliding element 12 under a function of the fixing part 130.

In at least one exemplary embodiment, the fixing part 130 includes a first fixing object 133 and a second fixing object 134. The first fixing object 133 and the second fixing object 134 are magnetic. The sliding object 135 is configured between the first fixing object 133 and the second fixing object 134. The sliding object 135 connects with the display element 11. The fixing part 130 is internally configured on the sliding element 12. The first support 110 is configured with a first group of the fixing part 130 and the sliding object 135. The second support 111 is configured with a second group of the fixing part 130 and one sliding object 135. For example, the first fixing object 133 of the first group is configured at a first end of the first sliding rail 121, the second fixing object 134 of the first group is configured at a second end of the first sliding rail 121, and the sliding object 135 of the first group connects with one display device of the display element 11. The first fixing object 133 of the second group is configured at a first end of the second sliding rail 122, the second fixing object 134 of the second group is configured at a second end of the second sliding rail 122, and the sliding object 135 of the second group connects with another display device of the display element 11.

The controller 136 can control the sliding object 135 to slide along the sliding element 12 to a certain position under the function of the fixing part 130. The controller 136 can be an electric current controller that controls a direction of current. In at least one exemplary embodiment, the first fixing object 133 and the second fixing object 134 are electromagnets. The sliding object 135 is a permanent magnet. The controller 136 is electrically connected with the first fixing object 133 and the second fixing object 134. The controller 136 can output a first current that flows through the first fixing object 133, and can output a second current that flows through the second fixing object 134. Therefore, each of the first fixing object 133 and the second fixing object 134 can generate a magnetic field. The controller 136 can control a magnetic force and a magnetic polarity of each of the first fixing object 133 and the second fixing object 134 by controlling a size of each of the first current and the second current, and a direction of each of the first current and the second current. Therefore, the display element 11 can be controlled to slide on the sliding element 12 according to an electromagnetic induction principle.

When the user uses the wearable device 100, by controlling the size and the direction of each of the first current and the second current using the controller 136, the magnetic polarity of the first fixing object 133 and the magnetic polarity of a first end of the sliding object 135 can be opposite to each other. Thereby, a magnetic attraction force between the first fixing object 133 and the sliding object 135 is generated. At the same time, the magnetic polarity of the second fixing object 134 and the magnetic polarity of a second end of the sliding object 135 can be same, such that a magnetic repulsion force between the second fixing object 134 and sliding object 135 is generated. Therefore, the two display devices that connect with the sliding objects 135 can be controlled to slide towards the extending portion 102 under the magnetic attraction force between the first fixing object 133 and the sliding object 135, and the magnetic repulsion force between the second fixing object 134 and sliding object 135. In this way, the display device can be moved to a first position that is in front of the eye of the user.

When the user does not need to use and view the wearable device 100 the display device can be moved away. By controlling the size and the direction of each of the first current and the second current using the controller 136, the magnetic polarity of the first fixing object 133 and the magnetic polarity of the first end of the sliding object 135 can be same, such that the magnetic repulsion force between the first fixing object 133 and the sliding object 135 is generated. At the same time, the magnetic polarity of the second fixing object 134 and the magnetic polarity of the second end of the sliding object 135 can be opposite to each other, such that the magnetic attraction force between the second fixing object 134 and the sliding object 135 is generated. Therefore, the display device that connects with the sliding object 135 can be controlled to slide away from the extending portion 102 under the magnetic attraction force between the second fixing object 134 and the sliding object 135, and the magnetic repulsion force between the first fixing object 133 and the sliding object 135, such that the display device that connects with the sliding object 135 can be moved to a second position away from the eye of the user.

In at least one exemplary embodiment, the frame 10 can further be configured with a limiting portion (not shown). The limiting portion can be configured at a position that is away from the extending portion 102. The limiting portion can prevent the display device from slipping off the frame 10.

In at least one exemplary embodiment, to move the display device to a predetermined position, a first magnetic repulsion force can be generated between the first fixing object 133 and the sliding object 135, and a second magnetic repulsion force can be generated between the second fixing object 134 and the sliding object 135 by controlling the direction of each of the first current and the second current using the controller 136. A size of the first magnetic repulsion force can be controlled to equal a size of second magnetic repulsion force by adjusting the magnitude of each of the first current and the second current. The display device connecting with the sliding object 135 can thus be fixed at the predetermined position.

In other exemplary embodiments, when the display device is moved to the predetermined position, a first magnetic attraction force can be generated between the first fixing object 133 and the sliding object 135, and a second magnetic attraction force can be generated between the second fixing object 134 and the sliding object 135 by controlling the direction of each of the first current and the second current using the controller 136. A magnitude of the first magnetic attraction force can be controlled to equal a magnitude of second magnetic attraction force by adjusting the magnitude of each of the first current and the second current. The display device connecting with the sliding object 135 can thus be fixed at the predetermined position.

In at least one exemplary embodiment, at least one of the first fixing object 133, the second fixing object 134, and the sliding object 135 can be an electromagnet that is electrically connected with the controller 136. Other magnetic elements can be the permanent magnets or the electromagnets. The controller 136 can control the display element 11 to slide on the sliding element 12 and be fixed at the predetermined position on the sliding element 12 by controlling the magnitude and direction of the current through the electromagnet.

In other exemplary embodiments, the fixing portion 130 can include only one fixing object. At least one fixing object and the sliding object 135 can be the electromagnet that is electrically connected with the controller 136, another one can be the permanent magnet or the electromagnet. The controller 136 can control the display element 11 to slide on the sliding element 12 fix at the predetermined position on the sliding element 12 according to the electromagnetic induction principle by controlling the magnitude and direction of the current that flows through the electromagnet.

The exemplary embodiments shown and described above are only examples. Even though numerous characteristics and advantages of the present disclosure have been set forth in the foregoing description, together with details of the structure and function of the present disclosure, the disclosure is illustrative only, and changes may be made in the detail, including in matters of shape, size and arrangement of the parts within the principles of the present disclosure, up to and including the full extent established by the broad general meaning of the terms used in the claims.

What is claimed is:

1. An wearable device comprising a frame and a display element, wherein the frame internally comprises a sliding element, and the display element is movably attached to the sliding element.

2. The wearable device according to claim 1, wherein the frame comprises a support portion, the sliding element is mounted on the support portion, and the sliding element has a groove shape.

3. The wearable device according to claim 2, wherein the frame further comprises an extending portion, a first end of the extending portion connects with the support portion, and a second end of the extending portion extends away from the support portion.

4. The wearable device according to claim 3, wherein the display element comprises two display devices, the two display device are configured symmetrically.

5. The wearable device according to claim 3, wherein the display element comprises two display devices, the frame internally comprises a driving portion, the driving portion drives the two display devices to slide towards the extending portion or drives the two display devices to slide away from the extending portion.

6. The wearable device according to claim 5, wherein the driving portion comprises a fixing portion, a sliding object, and a controller, the fixing portion is internally configured in the sliding element, the sliding object connects with the display element, the controller controls the sliding object to slide relative to the fixing portion according to a magnetic force generated between the fixing portion and the sliding object.

7. The wearable device according to claim 6, wherein at least one of the fixing portion and the sliding object is an electromagnetic, the electromagnetic is electrically connected with the controller.

8. The wearable device according to claim 7, wherein the controller controls a magnitude and a direction of the magnetic force generated between the fixing portion and the sliding object by controlling a magnitude and a direction of a current that flows through the electromagnetic.

9. The wearable device according to claim 7, wherein the controller controls the two display devices to slide towards or away from the extending portion by controlling the magnetic force generated between the fixing portion and the sliding object, the magnetic force is selected from a group consisting of a magnetic attraction force, a magnetic repulsion force, and a combination of the magnetic attraction force and the magnetic repulsion force.
